(19) United States
(12) Patent Application Publication
(10) Pub. No.: US 2022/0323805 A1
(43) Pub. Date: Oct. 13, 2022

(54) FIRE SUPPRESSION NOZZLES AND SYSTEMS

(71) Applicant: Tyco Fire Products LP, Lansdale, PA (US)

(72) Inventors: Michael J. Fisher, Marinette, WI (US); Kyle Raboin, Marinette, WI (US)

(73) Assignee: Tyco Fire Products LP, Lansdale, PA (US)

(21) Appl. No.: 17/633,757

(22) PCT Filed: Aug. 7, 2020
(86) PCT No.: PCT/IB2020/057493

§ 371 Date: Feb. 8, 2022

Related U.S. Application Data
(60) Provisional application No. 62/884,809, filed on Aug. 9, 2019.

(51) Int. Cl. A62C 31/05; A62C 99/00

(52) U.S. Cl. CPC A62C 31/05; A62C 99/0018

(57) ABSTRACT

A fire suppression nozzle includes an outer tubular member, an inner tubular member co-cylindrical with the outer tubular member and extending through the outer tubular member, wherein the inner tubular member comprises a first chamber, and the outer tubular member and the inner tubular member cooperatively define a second chamber, multiple disc members extending radially outward relative to an outer surface of the outer tubular member, a first and second set of openings extending through the inner tubular member to fluidly couple the first chamber with the second chamber, and a first and second set of discharge openings extending through the outer tubular member to fluidly couple the second chamber with an external environment, wherein the first and second set of openings are longitudinally aligned with the first and second set of discharge openings.

### CROSS-REFERENCE TO RELATED PATENT APPLICATIONS

This application claims the benefit of and priority to U.S. Provisional Application No. 62/884,809, filed Aug. 9, 2019, which is incorporated herein by reference in its entirety.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppression agent throughout the area. The fire suppressant agent then suppresses or controls (e.g., prevents the growth of) the fire. Certain types of equipment (such as data storage equipment) may be sensitive to sound waves produced by the fire suppression system.

### SUMMARY OF THE INVENTION

One embodiment of the disclosure relates to a fire suppression nozzle including an outer tubular member, an inner tubular member co-cylindrical with the outer tubular member and extending through the outer tubular member, wherein the inner tubular member comprises a first chamber, and the outer tubular member and the inner tubular member cooperatively define a second chamber, multiple disc members extending radially outward relative to an outer surface of the outer tubular member, a first and second set of openings extending through the inner tubular member to fluidly couple the first chamber with the second chamber, and a first and second set of discharge openings extending through the outer tubular member to fluidly couple the second chamber with an external environment, wherein the first and second set of openings are longitudinally aligned with the first and second set of discharge openings.

Another embodiment of the disclosure relates to a fire suppression nozzle including an outer tubular member, an inner tubular member that is co-cylindrical with the outer tubular member and extends within the outer tubular member, wherein the inner tubular member comprises a first chamber, and the outer tubular member and the inner tubular member cooperatively define a second chamber, a set of openings that extend through the inner tubular member to fluidly couple the first chamber with the second chamber, and a set of discharge openings that extend through the outer tubular member to fluidly couple the second chamber with an external environment, wherein the set of openings are longitudinally positioned in line with the set of discharge openings.

Another embodiment of the disclosure relates to a fire suppression system including a fire suppression agent container configured to store and discharge a fire suppression agent, wherein the fire suppression agent is a halocarbon agent, and a fire suppression nozzle including an outer tubular member, an inner tubular member extending within the outer tubular member, wherein the inner tubular member comprises a first chamber, and the outer tubular member and the inner tubular member cooperatively define a second chamber, a set of openings that extend through the inner tubular member to fluidly couple the first chamber with the second chamber, and a set of discharge openings that extend through the outer tubular member to fluidly couple the second chamber with an external environment, wherein the fire suppression nozzle is fluidly coupled with the fire suppression agent container and is configured to discharge the fire suppression agent to a surrounding area. In various embodiments, this fire suppression system includes one or more fire suppression nozzle according to the various embodiments of fire suppression nozzles described herein.

Another embodiment of the disclosure relates to a fire suppression system including a fire suppression agent container configured to store and discharge a fire suppression agent, wherein the fire suppression agent is a halocarbon agent, and a fire suppression nozzle including an outer tubular member, an inner tubular member extending within the outer tubular member, wherein the inner tubular member comprises a first chamber, and the outer tubular member and the inner tubular member cooperatively define a second chamber, multiple disc members that extend radially outward relative to the outer tubular member, a first and second set of openings that extend through the inner tubular member to fluidly couple the first chamber with the second chamber, and a first and second set of discharge openings that extend through the outer tubular member to fluidly couple the second chamber with an external environment, wherein the fire suppression nozzle is fluidly coupled with the fire suppression agent container and is configured to discharge the fire suppression agent to a surrounding area. In various embodiments, this fire suppression system includes one or more fire suppression nozzle according to the various embodiments of fire suppression nozzles described herein.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a perspective view of a fire suppression nozzle, according to some embodiments.

FIG. 2 is a side cross-sectional view of the fire suppression nozzle of FIG. 1, according to some embodiments.

FIG. 3 is a side view of the fire suppression nozzle of FIG. 1, according to some embodiments.

FIG. 4 is a graph showing sound output of the fire suppression nozzle of FIG. 1 with respect to flow rate, according to some embodiments.

FIG. 5 is a perspective view of a fire suppression nozzle, according to some embodiments.

FIG. 6 is a side sectional view of the fire suppression nozzle of FIG. 5, according to some embodiments.

FIG. 7 is a side view of the fire suppression nozzle of FIG. 5, according to some embodiments.

FIG. 8 is a graph showing sound output of the fire suppression nozzle of FIG. 5 with respect to flow rate, according to some embodiments.

FIG. 9 is a schematic diagram of a fire suppression system in which the fire suppression nozzle of FIGS. 1-3 or the fire suppression nozzle of FIGS. 5-7 may be implemented, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a fire suppression nozzle is configured to discharge or spread a fire suppression agent while reducing sound produced by the fire suppression agent flowing through the fire suppression nozzle. The fire suppression nozzle includes an inner tubular member, or an inner pipe, and an outer tubular member or an outer pipe. The inner tubular member and the outer tubular member can be co-axial, co-cylindrical, or centered relative to each other. In some embodiments, the inner tubular member threadingly and/or fixedly couples with a coupling and is configured to receive the fire suppression agent through the coupling. The fire suppression agent may be provided to the fire suppression nozzle by a fire suppression agent source (e.g., a pressure vessel) through a piping or plumbing system. The fire suppression agent can be driven to flow from the fire suppression agent source to the fire suppression nozzle by a pressure differential between the fire suppression agent source and the fire suppression nozzle.

The fire suppression nozzle also includes an upper member (e.g., a flange, a plate, etc.) and a lower member (e.g., a flange, a plate, etc.). The upper member extends radially outward from an outward facing surface of the inner tubular member and may fixedly couple with the outer tubular member. The lower member extends radially outward and substantially seals the outer tubular member, with the inner tubular member extending longitudinally toward the lower member. The inner tubular member may extend up to and abut a fiberglass disc that is positioned within the outer tubular member.

The inner tubular member includes an inner volume or a first chamber through which the fire suppression agent flows. The inner tubular member, the outer tubular member, the upper member, and the lower member cooperatively define an outer volume or a second chamber. The fire suppression agent is provided to the fire suppression nozzle through the coupling and into the first chamber of the fire suppression nozzle. The inner tubular member includes a plurality of openings that extend radially outward through sidewalls of the inner tubular member. The plurality of openings fluidly couple the first chamber with the second chamber such that the fire suppression agent may exit the first chamber and enter the second chamber through the plurality of openings. In some embodiments, the inner tubular member includes a first set and a second set of openings or apertures that are longitudinally disposed or positioned a distance apart along the inner tubular member. In this way, the fire suppression agent is split into two flow paths such that a first portion of the fire suppression agent may flow through the first set of openings into the second chamber, while a second portion of the fire suppression agent flows through the second set of openings into the second chamber. The second chamber may function as an expansion chamber such that the fire suppression agent expands as it enters the second chamber, thereby reducing sound produced during use of the fire suppression nozzle.

The outer tubular member includes a plurality of discharge openings that are configured to fluidly couple the second chamber with an external environment about the fire suppression nozzle. The plurality of discharge openings can extend radially outward through a sidewall of the outer tubular member. In this way, the fire suppression agent may be discharged through the plurality of discharge openings to a service area, a room, etc. The outer tubular member can include multiple sets of the plurality of discharge openings. Each set of the plurality of discharge openings can have multiple rows which are longitudinally offset relative to each other.

In some embodiments, the fire suppression nozzle includes a first disc, a second disc, and a third disc. The discs may be manufactured from a fiberglass and can be configured to absorb sound waves that result from the fire suppression agent flowing through the fire suppression nozzle. The discs can protrude radially outward from a radially outward facing surface of the outer tubular member. The various sets of the plurality of discharge openings may be positioned longitudinally between neighboring discs. For example, a first set of discharge openings can be positioned between the first disc and the second disc, while a second set of discharge openings can be positioned between the second disc and the third disc. In some embodiments, the first disc, the second disc, and the third disc are irregular shaped, polygonal shaped, square shaped, etc.

The fire suppression agent may be a halo-carbon agent, a gaseous fire suppression agent, or a liquid fire suppression agent. In some embodiments, the fire suppression agent is a liquid fire suppression agent that has been vaporized. In this way, the fire suppression agent can be in a saturated state and may include both liquid and gaseous fire suppression agent.

In some embodiments, the fire suppression nozzle includes a wire mesh that is positioned in the second chamber (e.g., between the inner tubular member and the outer tubular member). The wire mesh can be a flat mesh that is coiled, wound, rolled, etc., before being inserted into the second chamber. The wire mesh may engage a radially inward facing surface of the outer tubular member. Advantageously, the wire mesh includes a plurality of openings such that the fire suppression agent can flow through the wire mesh. The wire mesh may reduce the sound output by the fire suppression nozzle during use. The wire mesh can have a mesh count of 16 wires per inch in both directions (e.g., in a first or horizontal direction and a second or vertical direction that is perpendicular to the first or horizontal direction).

Advantageously, the fire suppression nozzle can suppress the sound produced by the fire suppression agent flowing through the fire suppression nozzle. The fire suppression nozzle can be used in applications or settings where equipment (e.g., data storage equipment) or people are sensitive to the sound produced by the fire suppression nozzle. For example, the fire suppression nozzle can be used in data centers to prevent or suppress fires, while producing sound waves that do not damage the data storage equipment.

The fire suppression nozzles disclosed herein may includes any of the features, configuration, components, functionality, etc., of the nozzle 101 as described in greater detail with reference to U.S. application Ser. No. 15/550,332, filed Dec. 2, 2016, or the nozzle 101 described in greater detail with reference to U.S. application Ser. No. 15/550,517, filed Dec. 2, 2016, the entire disclosures of which are incorporated by reference herein.

### Fire Suppression Nozzle

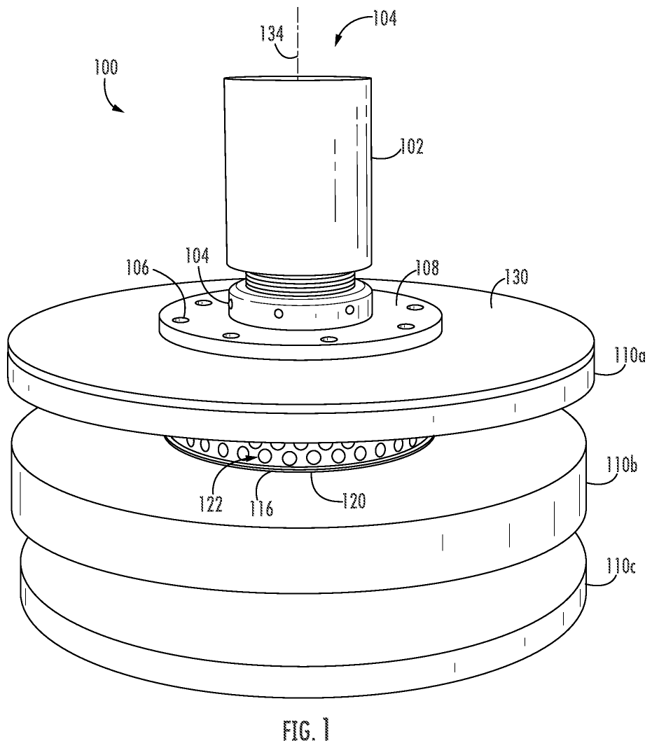

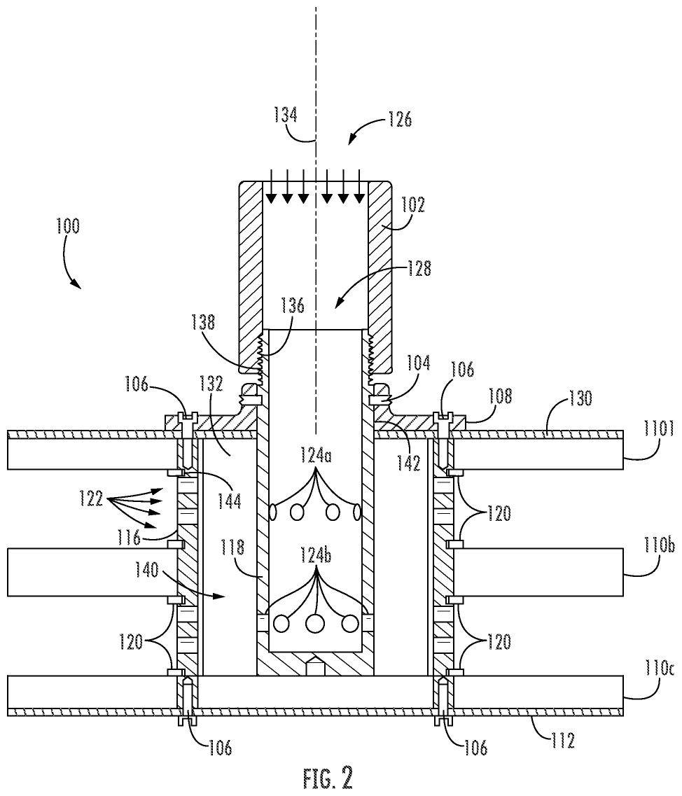

Referring particularly to FIGS. 1-3, a fire suppression nozzle 100 includes a coupling 102, an inner pipe 118, an upper plate 130, a flange 108, a lower plate 112, and multiple discs 110a-c (e.g., fiberglass discs, etc.). The fire suppression nozzle 100 is configured to receive a fire suppression agent (e.g., a gas) through an inlet end 126 of the coupling 102 and distribute, spray, spread, etc., the fire suppression agent. The fire suppression nozzle 100 may discharge the fire suppression agent in substantially all directions (e.g., a full 360 degrees) about a longitudinal axis 134 that extends through the fire suppression nozzle 100.

The longitudinal axis 134 may extend centrally through the coupling 102 of the fire suppression nozzle 100, the discs 110a-c, the inner pipe 118, and the outer pipe 116. The coupling 102 is configured to receive the fire suppression through the inlet end 126 or through an inlet aperture, opening, hole, window, etc., at the inlet end 126. The coupling 102 and the inner pipe 118 include/define an inner volume 128 or a first chamber that extends along the longitudinal axis 134. The coupling 102 is fixedly coupled, attached, adhered, threadingly coupled, etc., with the inner pipe 118. The inner pipe 118 can include threads 136 along an outer sidewall. The threads 136 are configured to engage or fixedly couple with a corresponding set of threads 138 of the coupling 102 that extend along an inner surface of the coupling 102.

The inner pipe 118 extends inward relative to an outer volume 140 or a second chamber of the fire suppression nozzle 100. The outer volume 140 is defined by the inner pipe 18, the upper plate 130, the lower plate 112, and the outer pipe 116. The upper plate 130 can be any generally planar, disc-shaped, or circular member. For example, the upper plate 130 can be a steel plate, an aluminum plate, a disc-shaped member, a thin disc, etc. The upper plate 130 may extend laterally outward from the inner pipe 118, or more particularly, from a radially outward facing surface of the inner pipe 118. The upper plate 130 can have a central aperture 142 that is configured to receive the inner pipe 118 therethrough. A flange, a support member, a structural member, etc., shown as flange 108 can be positioned between the inner pipe 118 and the upper plate 130. The flange 108 provides additional structural strength between the inner pipe 118 and the upper plate 130. The flange 108 can have a shoulder or a stepped shape and extends both longitudinally along an outer surface of the inner pipe 118 and laterally along an outer surface of the upper plate 130. For example, a portion of the flange 108 may extend radially outward from the longitudinal axis 134 along an outer surface of the upper plate 130, while another portion of the flange 108 may extend longitudinally along the inner pipe 118 or along an outer surface of the inner pipe 118.

The inner pipe 118 and the upper plate 130 can be sealingly coupled with each other such that the inner pipe 118 can receive fire suppression agent through the inlet end 126 without the fire suppression agent leaking. The flange 108 is fixedly coupled with the inner pipe 118 through one or more set screws or fasteners, shown as screws 104. The screws 104 extend radially through the flange 108 and can engage, press into, interfere with, be received within, etc., the inner pipe 118. The screws 104 may thread into the flange 108 and can be tightened or adjusted until the screws 104 provide a clamping force to the inner pipe 118. The screws 104 can be adjusted individually such that the clamping force is provided uniformly about the inner pipe 118. In some embodiments, the screws 104 engage a circumferential groove extending about inner pipe 118.

The upper plate 130 fixedly couples with the flange 108 and with the outer pipe 116. The outer pipe 116 and the inner pipe 118 can be substantially co-cylindrical with each other. However, the outer pipe 116 has a diameter/radius that is greater than the diameter/radius of the inner pipe 118. The upper plate 130 can be fixedly coupled with the outer pipe 116 and the flange 108 through one or more fasteners, screws, cap screws, etc., shown as fasteners 106. The fasteners 106 can extend in the longitudinal direction and may be spaced apart along substantially an entire circumference of the flange 108. The fasteners 106 may extend through the flange 108 in the longitudinal direction, through the upper plate 130, and threadingly couple with the outer pipe 116.

The fire suppression nozzle 100 also includes a second or a lower plate 112 that is longitudinally positioned a distance away from the upper plate 130. The lower plate 112 can have a same shape as the upper plate 130 and may be a disc-shaped member similar to the upper plate 130. The lower plate 112 extends radially outward from the longitudinal axis 134 and defines a bottom of the fire suppression nozzle 100.

The outer pipe 116 extends longitudinally between the upper plate 130 and the lower plate 112. Specifically, the outer pipe 116 can extend between longitudinally inward facing surfaces of the upper plate 130 and the lower plate 112. The outer pipe 116 can be any tubular member, or walled cylindrical member that includes an inner volume for the fire suppression agent to flow through.

The fire suppression nozzle 100 also includes a first disc 110a, a second disc 110b, and a third disc 110c. The first disc 110a, the second disc 110b, and the third disc 110c are longitudinally spaced apart from each other. In some embodiments, the first disc 110a, the second disc 110b, and the third disc 110c are equally spaced apart along the longitudinal axis 134. The first disc 110a, can be adhered or fixedly coupled with the upper plate 130. Specifically, the first disc 110a may be in direct contact with, abut, or directly engage a longitudinal inward facing surface of the upper plate 130.

The first disc 110a can be held in place or fixedly coupled with the outer pipe 116 by a retaining ring 120. The fire suppression nozzle 100 includes multiple retaining rings 120 that are configured to hold each of the discs 110 in a longitudinal position on the fire suppression nozzle 100. The retaining rings 120 are configured to engage, be received within, etc., grooves, steps, shoulders, depressions, tracks, etc., shown as grooves 144 that extend along an outer surface of the outer pipe 116.

The first disc 110a is held in place a single retaining ring 120 that is received within a corresponding groove 144 on the outer pipe 116. The first disc 110a extends radially outward from an outward facing surface of the outer pipe 116 along a longitudinal facing surface of the upper plate 130 (e.g., a side of the upper plate 130 that faces the lower plate 112). The first disc 110a can extend radially outward from the outer surface of the outer pipe 116 to an outermost radius of the upper plate 130.

The second disc 110b is held in place at a longitudinal position that is approximately a longitudinal center or midpoint of the outer pipe 116. The second disc 110b is held in place by two of the retaining rings 120 and corresponding grooves 144. The second disc 110b can have a longitudinal thickness that is substantially equal to the longitudinal thickness of the first disc 110a. In other embodiments, the second disc 110b has a longitudinal thickness that is greater than the longitudinal thickness of the first disc 110a.

The third disc 110c is held in place at the lower plate 112 by another retaining ring 120 that engages a corresponding groove 144. The third disc 110c may be similarly configured to the first disc 110a but at an opposite end of the outer pipe 116. For example, the third disc 110c extends radially outward from an outer surface of the outer pipe 116 and is directly adjacent to (e.g., in direct contact with) a corresponding surface of the lower plate 112. The third disc 110c may abut, be in contact with, etc., a longitudinal inward facing surface of the lower plate 112 (e.g., a surface of the lower plate 112 that faces the upper plate 130).

The fire suppression nozzle 100 may also include a bottom member 114 that may be manufactured from the same material as the discs 110. In some embodiments, the bottom member 114 directly abuts, contacts, engages, etc., the longitudinal inward facing surface of the lower plate 112. The bottom member 114 substantially covers an entire cross-sectional area of the outer volume 140. The bottom member 114 extends between an inner surface of the outer pipe 116. The bottom member 114 may have a circular shape and can have a longitudinal thickness that is substantially equal to the longitudinal thickness of the third disc 110c.

The bottom member 114 is positioned between the inner pipe 118 and the lower plate 112. In some embodiments, the inner pipe 118 directly engages or contacts an inward facing surface of the bottom member 114. Likewise, the lower plate 112 directly engages or contacts an opposite surface of the bottom member 114 (e.g., an outward facing surface of the bottom member 114).

The lower plate 112 is fixedly coupled with the outer pipe 116 through fasteners 106. The fasteners 106 extend through the lower plate 112 and threadingly or fixedly couple with the outer pipe 116. In other embodiments, the lower plate 112 is fixedly coupled with the outer pipe 116 using an adhesive, a snap fit, an interference fit, a press fit, etc. In still other embodiments, the lower plate 112 is fixedly coupled with the outer pipe 116 using a combination of the fasteners 106 and an adhesive. A seal can also be positioned between the lower plate 112 and the outer pipe 116 or between the upper plate 130 and the outer pipe 116.

The outer pipe 116 includes a plurality of holes, apertures, openings, windows, etc., shown as openings 122. The openings 122 extend radially through the outer pipe 116 to fluidly couple the outer volume 140 of the outer pipe 116 with surrounding environment. In some embodiments, the openings 122 are patterned about the outer pipe 116 (e.g., in a honey-comb pattern). The openings 122 may have a uniform size and/or shape (e.g., a same radius) or may have varying sizes and/or shapes. In some embodiments, the openings 122 have a circular shape. In other embodiments, the openings 122 have a square shape, a hexagonal shape, etc., or any other cross-sectional shape.

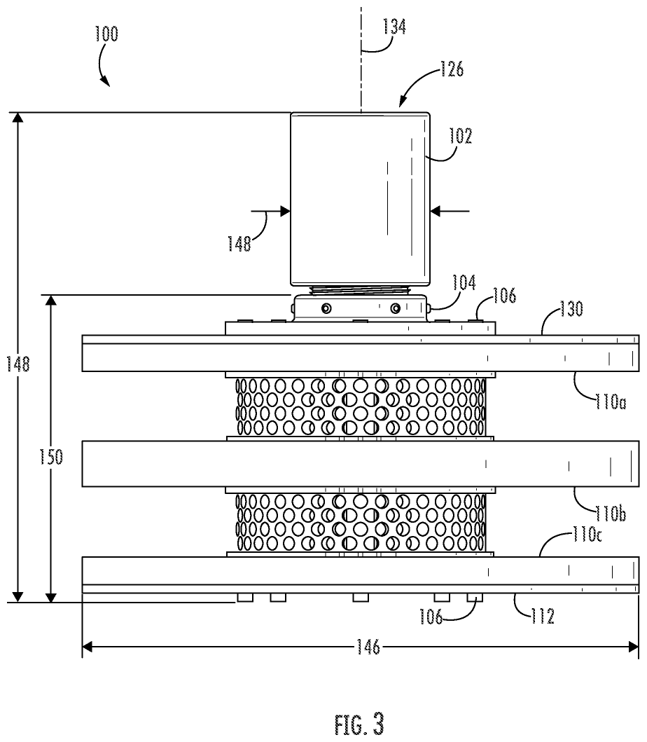

The openings 122 may cover substantially an entire surface area of the outer pipe 116. In some embodiments, the openings 122 cover only portions of the outer pipe 116 that are between the discs 110. For example, the openings 122 may cover portions of the outer pipe 116 that are longitudinally between corresponding surfaces of the first disc 110a and the second disc 110b. Likewise, the openings 122 may cover portions of the outer pipe 116 that are longitudinally between corresponding surfaces of the second disc 110b and the third disc 110c. The openings 122 facilitate the egress of fire suppression agent from the outer volume 140. The outer pipe 116 can include two sets of the openings 122. Each set of the openings 122 can include four rows of openings 122. For example, a first set of four rows of openings 122 may be longitudinally positioned between the first disc 110a and the second disc 110b, while a second set of four rows of openings 122 may be longitudinally positioned between the second disc 110b and the third disc 110c (see, e.g., FIG. 3).

The inner pipe 118 includes a plurality of openings, apertures, windows, holes, etc., shown as apertures 124 that extend through the inner pipe 118 to fluidly couple the inner volume 128 with the outer volume 140. The inner pipe 118 can include a first set of apertures, shown as apertures 124a, and a second set of the apertures, shown as apertures 124b. The apertures 124a and the apertures 124b are longitudinally spaced apart. In other embodiments, the inner pipe 118 includes more than two sets of apertures 124. For example, the inner pipe 118 can include several sets of the apertures 124 that are each spaced apart longitudinally. The apertures 124a may be angularly spaced apart about the longitudinal axis 134. For example, each aperture 124 may be angularly spaced apart 45 degrees, 30 degrees, etc.

The apertures 124a can be positioned longitudinally at a position that is substantially in-line with the openings 122 between the disc 110a and the disc 110b. In some embodiments, the size of the apertures 124a, the number of the apertures 124a, the shape, position, etc., of the apertures 124a determines a discharge rate or any other discharge characteristics of the fire suppression nozzle 100. For example, the apertures 124 can be customized for a specific application of the fire suppression nozzle 100. The size of the apertures 124 can be adjusted during manufacturing to achieve a desired discharge rate and/or a desired sound output of the fire suppression nozzle 100 for a specific application of the fire suppression nozzle 100. In this way, the fire suppression nozzle 100 can be tailored to achieve a desired discharge rate and/or a desired sound output for the specific application of the fire suppression nozzle 100.

The apertures 124b can also be aligned with the corresponding openings 122. For example, the apertures 124b can be longitudinally positioned such that the apertures 124b are aligned with the openings 122 that are between the discs 110b and 110c. The size, shape, orientation, position, pattern, etc., of the apertures 124b can also be adjusted (e.g., during manufacturing) to achieve a desired discharge rate and/or a desired sound output of the fire suppression nozzle 100.

The fire suppression nozzle 100 includes a mesh, a rack, a wire mesh, etc., shown as wire mesh 132. The wire mesh 132 can have a cylindrical shape and may be co-cylindrical with the inner pipe 118 and the outer pipe 116. The wire mesh 132 may be a thin cylindrical member that is positioned between the inner pipe 118 and the outer pipe 116. The wire mesh 132 can be adjacent an interior surface of the outer pipe 116, adjacent an exterior surface of the inner pipe 118, or somewhere in between the inner pipe 118 and the outer pipe 116. The wire mesh 132 can be a flat mesh having a mesh count MC of 16 wires per inch. The wire mesh 132 can be pre-wound or coiled into a spiral, and placed inside the outer volume 140 of the outer pipe 116. The wire mesh 132 may unwind some amount such that the wire mesh 132 engages or contacts the radially inward facing surface of the outer pipe 116.

The wire mesh 132 can be woven and may have various openings to allow the flow of the fire suppression agent therethrough. The wire mesh 132 may be manufactured from wire having a diameter d (e.g., 0.035 inches) and may have mesh count MC of approximately 16 wires per inch in either direction (e.g., in both perpendicular directions).

The fire suppression agent is provided to the fire suppression nozzle 100 through the inlet end 126 of the coupling 102. The fire suppression agent then flows through the inner volume 128 of the coupling 102 and the inner pipe 118. The fire suppression agent may then exit the inner volume 128 of the coupling 102 and the inner pipe 118 and enter the outer volume 140 of the outer pipe 116 through the apertures 124. The fire suppression agent may be split apart into two flow paths through the apertures 124a and the apertures 124b. The outer volume 140 of the outer pipe 116 (e.g., the inner volume defined between the radially inward facing surface of the outer pipe 116 and the radially outward facing surface of the inner pipe 118) may function as an expansion chamber, such that the fire suppression agent expands upon entering the outer volume 140. Advantageously, this can reduce acoustic output of the fire suppression nozzle 100 during operation.

The apertures 124a and 124b can split the fire suppression agent into two flow paths. Specifically, some of the fire suppression agent flows through the first set of apertures 124a, while some of the fire suppression agent flows through the second set of apertures 124b. The fire suppression agent flows through the first and second set of apertures, 124a and 124b and expands in the outer volume 140. The fire suppression agent may pass through the wire mesh 132 which reflects sound waves. The sound waves of the fire suppression agent are redirected by the wire mesh 132 which may reduce a sound level or sound output of the fire suppression nozzle 100 during operation.

The fire suppression agent passes through the wire mesh 132 and exits the outer volume 140 of the outer pipe 116 through the openings 122. The fire suppression agent may exit through the openings 122 between the discs 110. For example, the fire suppression agent may exit through the openings 122 between the discs 110a and 110b, as well as through the openings 122 between the discs 110b and 110c. The fire suppression agent can then be directed, dispersed, output, etc., from the fire suppression nozzle 100. As the fire suppression agent exits the outer volume 140 of the outer pipe 116 through the openings 122, the discs 110 can absorb soundwaves. For example, the soundwaves may propagate outward from the openings 122 and be absorbed by the discs 110.

Advantageously, the fire suppression nozzle 100 facilitates a reduced sound-level or output (e.g., a reduced decibel level) fire suppression nozzle. The fire suppression nozzle 100 may have a sound output or decibel level, during operation, that is approximately less than or equal to 120 decibels. The fire suppression nozzle 100, advantageously, can be used to provide fire suppression agent to an area, while protecting items and/or people that are sensitive to noise.

Referring particularly to FIG. 3, the fire suppression nozzle 100 can have an overall height 148 of approximately 8.8 inches or 224 millimeters. The coupling 102 can have a diameter of approximately 2.5 inches or 64 millimeters. The flange 108, the outer pipe 116, and the lower plate 112 can have an overall longitudinal height 150 that is approximately 5.5 inches or 140 millimeters. The fire suppression nozzle 100 can have a maximum diameter 146 of 10.0 inches or 254 millimeters. The fire suppression nozzle 100 can have a total weight of 7.9 pounds (with the coupling 102) or 5.7 pounds without the coupling 102. In some embodiments, the fire suppression nozzle 100 is configured to discharge the fire suppression agent at a maximum rate of 33 lb/sec or 15 kg/sec. In some embodiments, the fire suppression nozzle 100 is configured to provide the fire suppression agent over a coverage area of 1033 square feet or 95.9 square meters.

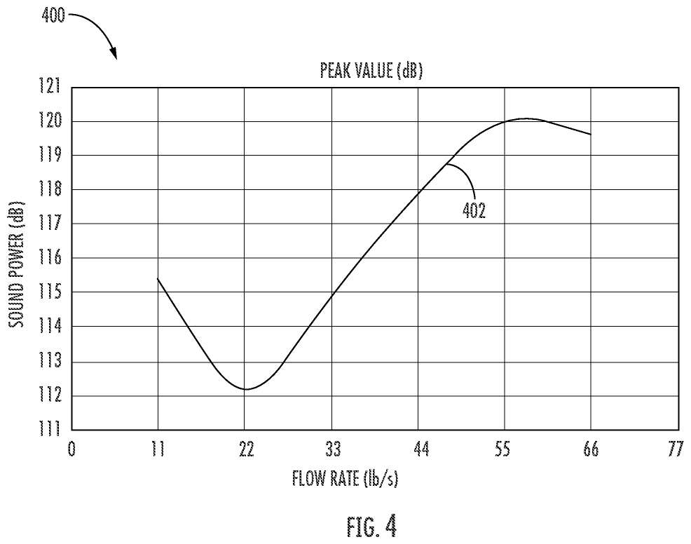

Referring particularly to FIG. 4, a graph 400 shows sound output (the Y-axis, in decibels) of the fire suppression nozzle 100 with respect to flow rate of the fire suppression agent flowing through the fire suppression nozzle 100. Graph 400 includes series 402 that shows the relationship between sound output and the flow rate of the fire suppression agent. As shown in graph 400, the fire suppression nozzle 100 achieves a minimum sound output of 112 dB at approximately 22 lb/sec. Likewise, the fire suppression nozzle 100 achieves a maximum sound output of approximately 120 dB at approximately 55 lb/sec.

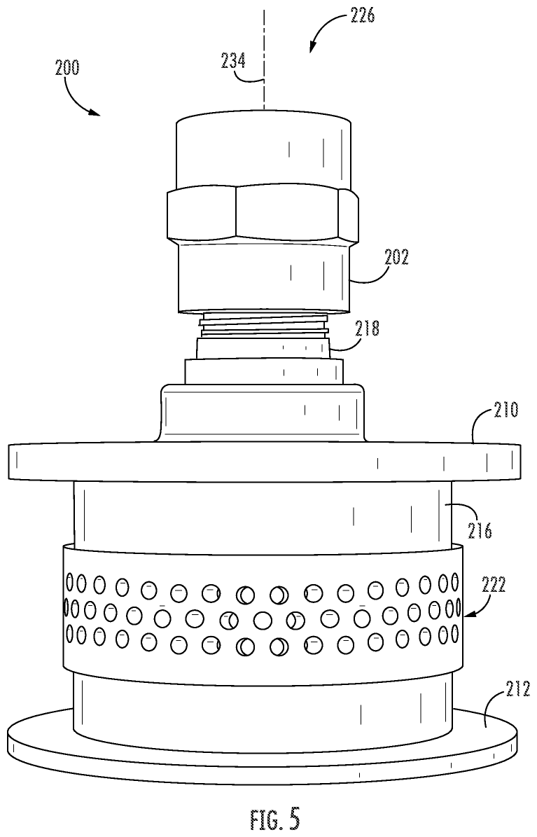

Referring particularly to FIGS. 5-7, another fire suppression nozzle 200 is shown, according to some embodiments. In some embodiments, the fire suppression nozzle 200 is the same as or similar to the fire suppression nozzle 100. For example, the fire suppression nozzle 200 can include similar configurations, components, and/or features of the fire suppression nozzle 100. The fire suppression nozzle 200 can be a smaller or more compact version of the fire suppression nozzle 100 that is designed and configured for lower flow rate applications, while still achieving desired noise reduction.

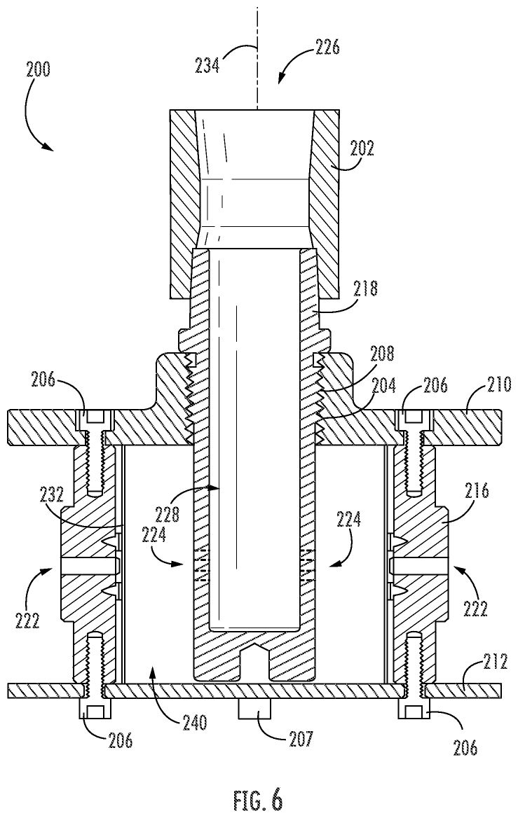

Referring particularly to FIGS. 5 and 6, the fire suppression nozzle 200 includes a coupling 202, an inner pipe 218, and an outer pipe 216. The coupling 202 can be similar to the coupling 202 of the fire suppression nozzle 100. In some embodiments, the coupling 202 is configured to threadingly couple with the inner pipe 218. For example, the coupling 202 can include threads that extend along an inner surface of the coupling 202 and are configured to engage and threadingly couple with coupling 202 with corresponding threads of the inner pipe 218 that extend along an outer surface of the inner pipe 218.

The inner pipe 218 and the outer pipe 216 are fixedly coupled with an upper flange 210 and a lower plate or a lower member 212. The upper flange 210 can be fixedly coupled with the outer pipe 216 through fasteners 206. The fasteners 206 may extend through the upper flange 210 and into the outer pipe 216 to fixedly couple the upper flange 210 with the outer pipe 216. Likewise, the lower plate 212 can fixedly couple with the outer pipe 216 through fasteners 206. The fasteners 206 may extend through the lower plate 212 and fixedly couple with the outer pipe 216.

The inner pipe 218 can threadingly couple with the flange 210. Specifically, the inner pipe 218 may include threads 208 that are configured to threadingly engage threads 204 of the outer pipe 216. The inner pipe 218 can extend through an aperture of the flange 210 and threadingly couples or fixedly couples with the flange 210. The inner pipe 218 and the flange 210 may sealingly couple (e.g., through threads 204 and threads 208) such that the fire suppression agent is restricted from seeping out of the inner volume 228 of the inner pipe 218.

The inner pipe 218 can include National Pipe Threads (NPT) for threadingly coupling the inner pipe 218 with the coupling 202. The coupling 202 can include NPT threads configured to engage the NPT threads of the inner pipe 218. The coupling 202 can include inner or outer threads at an opposite end that are either NPT threads or British Standard Pipe Threads (BSPT). In this way, the coupling 202 can be an adapter between NPT threads and BSPT threads, or can be an adapter between NPT and NPT threads. It should be understood that the coupling 102 can be the same as or similar to the coupling 202 and may be configured as an adapter between NPT threads that are on the inner pipe 118 and NPT or BSPT threads.

The fire suppression nozzle 200 includes a longitudinal axis 234 that extends centrally through the inner pipe 218 and the outer pipe 216. The longitudinal axis 234 can be similar to or the same as the longitudinal axis 134 of the fire suppression nozzle 100 and defines a longitudinal direction.

The inner pipe 218 includes a plurality of openings, apertures, holes, bores, etc., shown as openings 224. The openings 224 fluidly couple an inner volume 228 or a first chamber of the inner pipe 218 with the an outer volume 240 or second chamber of the outer pipe 216. The openings 224 can include two sets of openings or holes that are angularly offset about the longitudinal axis 234 an entire 360 degrees. For example, the openings 224 can extend through the inner pipe 218 to fluidly couple the inner volume 228 of the inner pipe 218 with the outer volume 240 of the outer pipe 216.

The outer volume 240 of the outer pipe 216 can be defined between a radially outward facing surface of the inner pipe 218 and a radially inward facing surface of the outer pipe 216. The outer volume 240 of the fire suppression nozzle 200 may function the same as the outer volume 140 of the fire suppression nozzle 100. For example, the outer volume 240 may function as an expansion chamber for the fire suppression agent. As the fire suppression agent enters the outer volume 240 of the outer pipe 216, the fire suppression agent expands, thereby reducing sound output of the fire suppression nozzle 200.

The fire suppression nozzle 200 also includes a wire mesh 232 that may be similar to the wire mesh 132 of the fire suppression nozzle 100. The wire mesh 232 includes openings and may have a mesh count MC that is the same as or similar to the mesh count MC of the wire mesh 132. For example, the wire mesh 232 can have a mesh count MC of approximately 16 wires per inch. The wire mesh 232 may reflect sound waves from the fire suppression agent, thereby facilitating reducing the sound output of the fire suppression nozzle 200. The wire mesh 232 can be coiled or wound before being installed between the inner pipe 118 and the outer pipe 116.

The inner pipe 218 and the outer pipe 216 can be co-cylindrical with each other and may both be centered about the longitudinal axis 234. The fire suppression agent enters the inner volume 228 of the inner pipe 218 through an inlet 226 or an opening in the coupling 202. The fire suppression agent flows through the inner volume 228 (e.g., in a longitudinal direction, along the longitudinal axis 234) of the coupling 202 and the inner pipe 218, then enters the outer volume 240 through the openings 224. The fire suppression agent may flow radially outward through the openings 224 into the outer volume 240 and expand in the outer volume 240.

The fire suppression agent then expands in the outer volume 240, and exits the outer volume 240 through a plurality of openings, apertures, holes, bores, etc., shown as openings 222 of the outer pipe 216. The outer pipe 216 can include three rows of openings 222 that extend through a sidewall of the outer pipe 216. The size and/or shape of the openings 222 may be uniform (e.g., a constant radius or a constant diameter), or may vary. In some embodiments, the openings 222 are staggered such that an upper row of the openings and a lower row of the openings 222 are radially aligned, but angularly offset relative to a central row of the openings 222.

The fire suppression agent is emitted, discharged, output, sprayed, etc., from the fire suppression nozzle 200 through the openings 222. The openings 222 fluidly couple the outer volume 240 of the outer pipe 216 with external surroundings of the fire suppression nozzle 200. The fire suppression nozzle 200 can be configured to discharge or output the fire suppression agent in a full range of 360 degrees (e.g., the openings 222 may be angularly offset a full 360 degrees) or a partial range of 360 degrees (e.g., 180 degrees if the openings 222 are angularly offset and span only 180 degrees). It should be understood that other discharge patterns may be achieved by the span of the openings 222. For example, the openings 222 may span a range of 90 degrees, 270 degrees, etc. In this way, the fire suppression nozzle 200 may be directional such that the fire suppression agent is discharged in a particular direction or over a particular range.

The fire suppression nozzle 200 may include a fastener 207 that is centrally located (e.g., extends along the longitudinal axis 234) and fixedly couples the lower plate 212 with the inner pipe 218. The fastener 207 may extend longitudinally through the lower plate 212 and threadingly couple with a corresponding portion of the inner pipe 218 (e.g., a corresponding bore, a blind hole, etc.). Advantageously, the fastener 207 facilitates improved structural support for the inner pipe 218.

Advantageously, in some embodiments, the fire suppression nozzle 200 does not require discs such as the discs 110 shown in FIGS. 1-3, and is smaller and more compact than the fire suppression nozzle 100. As such, a lower face of the top plate may face an upper face of the lower plate (e.g., without intervening structure). The fire suppression nozzle 200 can be used for lower flow rate applications of the fire suppression agent while still providing sound reduction and fire suppression abilities.

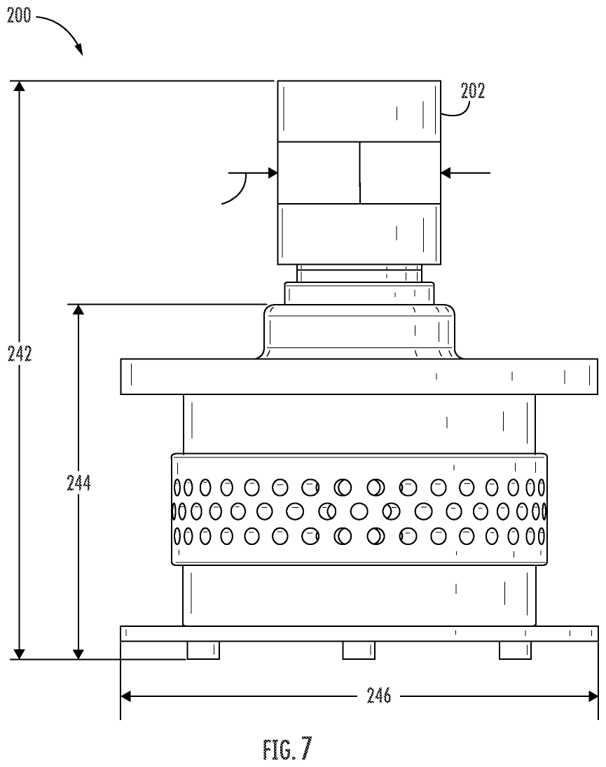

Referring particularly to FIG. 7, various dimensions of the fire suppression nozzle 200 are shown, according to some embodiments. The fire suppression nozzle 200 has an overall height 242 that is approximately 4.8 inches and a maximum diameter 246 that is approximately 4.0 inches. The coupling 202 may have an outer diameter 248 that is approximately 1.4 inches. The lower plate 212, the outer pipe 216, and the flange 210 can have an overall longitudinal height 244 that is approximately 3.0 inches. Advantageously, the fire suppression nozzle 200 is smaller and more compact than the fire suppression nozzle 100 without requiring discs 110. In some embodiments, the fire suppression nozzle 200 has a weight of 1.7 pounds with the coupling 202 and a weight of 1.2 pounds without the coupling 202. In some embodiments, the fire suppression nozzle 200 is configured to provide the fire suppression agent over a coverage area of 1033 square feet or 95.9 square meters.

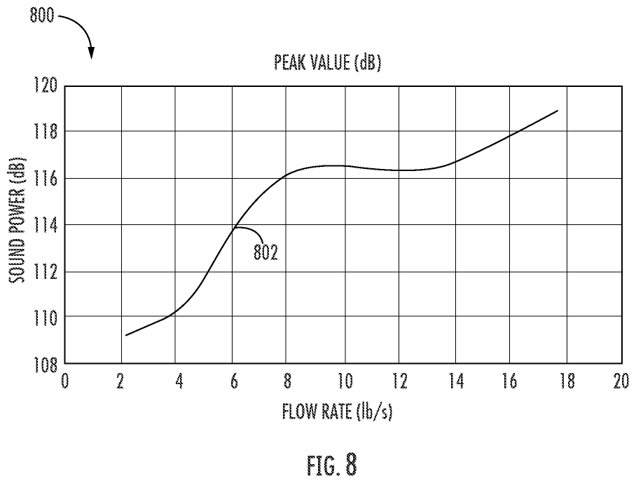

Referring particularly to FIG. 8, a graph 800 shows sound output (the Y-axis, in decibels) of the fire suppression nozzle 200 with respect to flow rate of the fire suppression agent flowing through the fire suppression nozzle 200. Graph 800 includes series 802 that shows the relationship between sound output and the flow rate of the fire suppression agent. As shown in graph 800, the fire suppression nozzle 200 achieves a local minimum sound output of approximately 116 dB at approximately 12 lb/sec. Likewise, the fire suppression nozzle 200 can achieve a local maximum sound output of approximately 116.6 dB at approximately 9 lb/sec. As the flow rate of the fire suppression agent increases beyond approximately 12 lb/sec, the sound output by the fire suppression nozzle 200 may increase.

### Fire Suppression System

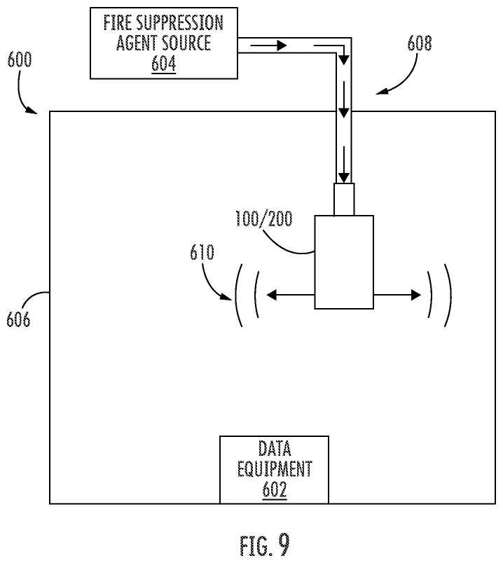

Referring particularly to FIG. 9, a fire suppression system 600 includes a fire suppression agent source 604, a piping system 608, and either the fire suppression nozzle 100 or the fire suppression nozzle 200. The fire suppression agent source 604 is configured to store the fire suppression agent and fluidly couples with the fire suppression nozzle 100/200. The fire suppression agent source 604 can fluidly couple with the fire suppression nozzle 100/200 through a piping system, a plumbing system, a conduit system, etc., shown as piping system 608. The piping system 608 can include various connectors, adapters, tubular members, hoses, conduits, etc., for transporting the fire suppression agent from the fire suppression agent source 604 to the fire suppression nozzle 100/200.

The fire suppression agent can be transported from the fire suppression agent source 604 to the fire suppression nozzle 100/200 by a pressure differential between the fire suppression agent source 604. For example, the fire suppression agent source 604 can be a pressure vessel, a container, a tank, etc., that stores the fire suppression agent at an elevated pressure. The fire suppression agent source 604 can include a valve, an actuator, and/or any other device configured to selectively fluidly couple the fire suppression agent source 604 with the fire suppression nozzle 100/200. The actuator and/or the valve may operate to fluidly couple the fire suppression agent source 604 with the fire suppression nozzle 100/200 in response to a fire detection in a space 606 that the fire suppression nozzle 100/200 services. The fire suppression nozzle 100/200 may discharge or spray or spread the fire suppression agent throughout the space 606 (e.g., a room, a zone, an area, a closet, a data center, etc.). In some embodiments, the space 606 includes various equipment, computer devices, data equipment, computer readable medium, etc., shown as data equipment 602. The data equipment 602 may be sensitive to sound waves 610 that are emitted by the fire suppression nozzle 100/200. Advantageously, the fire suppression nozzle 100/200 emits sound waves 610 and the fire suppression agent at a level such that the data equipment 602 is not damaged by the sound waves 610. Multiple nozzles 100/200 and additional piping than that shown in FIG. 9 may also be used.

It should be understood that the fire suppression agent may be propelled otherwise (e.g., by a suction pump, a discharge pump, etc.) from the fire suppression agent source 604 to the fire suppression nozzle 100/200. In some embodiments, the fire suppression agent is a vaporized liquid. For example, the fire suppression agent may be a halocarbon agent that includes carbon atoms. The fire suppression agent may be in a saturated state such that some of the fire suppression agent is in a liquid state, while other of the fire suppression agent is in a gas or vaporized state. The fire suppression agent can be any other gaseous or liquid, or semi-gaseous/semi-liquid fire suppression agent.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

1. A fire suppression nozzle comprising:
an outer tubular member;
an inner tubular member co-cylindrical with the outer tubular member and extending through the outer tubular member, wherein the inner tubular member comprises a first chamber, and the outer tubular member and the inner tubular member cooperatively define a second chamber;
a plurality of disc members extending radially outward relative to an outer surface of the outer tubular member;
a first and second set of openings extending through the inner tubular member to fluidly couple the first chamber with the second chamber; and
a first and second set of discharge openings extending through the outer tubular member to fluidly couple the second chamber with an external environment;
wherein the first and second set of openings are longitudinally aligned with the first and second set of discharge openings.

2. The fire suppression nozzle of claim 1, further comprising a flange and an upper plate, wherein:
the upper plate extends radially outward from a radially outward facing surface of the inner tubular member;
the upper plate abuts a corresponding surface of one of the plurality of disc members; and
the flange extends longitudinally along the radially outward facing surface of the inner tubular member and radially outward along a surface of the upper plate.

3. The fire suppression nozzle of claim 1, further comprising a lower plate, wherein the lower plate abuts a lower most one of the plurality of disc members and abuts a bottom surface of the outer tubular member.

4. (canceled)

5. The fire suppression nozzle of claim 1, wherein the inner tubular member, the outer tubular member, the first and second set of openings, and the first and second set of discharge openings define a fluid flow path, wherein the fluid flow path extends through the first chamber, into the second chamber through the first and second set of openings, and to the external environment through the first and second set of discharge openings.

6. The fire suppression nozzle of claim 1, further comprising a coupling threadingly coupled with the inner tubular member, wherein the coupling is an adapter configured to threadingly couple the fire suppression nozzle with another tubular member.

7. (canceled)

8. The fire suppression nozzle of claim 1, further comprising a wire mesh, wherein the wire mesh is disposed between the inner tubular member and the outer tubular member.

9. The fire suppression nozzle of claim 8, wherein the wire mesh has a mesh count of substantially sixteen wires per inch.

10. The fire suppression nozzle of claim 8, wherein the wire mesh is a flat mesh that is wound into a spiral and disposed between the inner tubular member and the outer tubular member.

11. The fire suppression nozzle of claim 8, wherein the wire mesh engages a radially inward facing surface of the outer tubular member.

12. The fire suppression nozzle of claim 8, wherein the wire mesh is configured to reduce a sound level produced by a fire suppression agent flowing through the fire suppression nozzle.

13. The fire suppression nozzle of claim 1, wherein the plurality of discs are configured to absorb sound produced by a fire suppression agent flowing through the fire suppression nozzle.

14. The fire suppression nozzle of claim 13, wherein the plurality of discs are manufactured from a fiberglass.

15. The fire suppression nozzle of claim 1, wherein each of the plurality of discs are fixedly coupled with the outer tubular member with one or more retaining rings.

16. The fire suppression nozzle of claim 1, wherein the first and second set of discharge openings each comprise a plurality of rows of discharge openings.

17. The fire suppression nozzle of claim 1, wherein the fire suppression nozzle outputs a maximum sound level of 120 decibels.

18. A fire suppression nozzle comprising:
an outer tubular member;
an inner tubular member that is co-cylindrical with the outer tubular member and extends within the outer tubular member, wherein the inner tubular member comprises a first chamber, and the outer tubular member and the inner tubular member cooperatively define a second chamber;
a set of openings that extend through the inner tubular member to fluidly couple the first chamber with the second chamber; and
a set of discharge openings that extend through the outer tubular member to fluidly couple the second chamber with an external environment;
wherein the set of openings are longitudinally positioned in line with the set of discharge openings.

19. The fire suppression nozzle of claim 18, further comprising a flange and a lower plate, wherein:
the flange threadingly and sealingly couples with a radially outward facing surface of the inner tubular member, and fixedly and sealingly couples with a corresponding surface of the outer tubular member; and
the lower plate fixedly and sealingly couples with the outer tubular member;
wherein the inner tubular member, the outer tubular member, the flange, and the lower plate define the second chamber.

20. (canceled)

21. The fire suppression nozzle of claim 18, wherein the inner tubular member, the outer tubular member, the set of openings, and the set of discharge openings define a fluid flow path, wherein the fluid flow path extends through the first chamber, into the second chamber through the set of openings, and to the external environment through the set of discharge openings.

22-28. (canceled)

29. The fire suppression nozzle of claim 18, wherein the set of discharge openings that extend through the outer tubular member to fluidly couple the second chamber with the external environment comprises three rows of openings.

30. A fire suppression system comprising:
a fire suppression agent container configured to store and discharge a fire suppression agent, wherein the fire suppression agent is a halocarbon agent; and
a fire suppression nozzle comprising:
an outer tubular member;
an inner tubular member extending within the outer tubular member, wherein the inner tubular member comprises a first chamber, and the outer tubular member and the inner tubular member cooperatively define a second chamber;
a set of openings that extend through the inner tubular member to fluidly couple the first chamber with the second chamber; and
a set of discharge openings that extend through the outer tubular member to fluidly couple the second chamber with an external environment;
wherein the fire suppression nozzle is fluidly coupled with the fire suppression agent container and is configured to discharge the fire suppression agent to a surrounding area.

31. (canceled)
